(19) United States
(12) Patent Application Publication
(10) Pub. No.: US 2016/0035202 A1
(43) Pub. Date: Feb. 4, 2016

(54) SMART REMOTE STOVE FIRE MONITOR AND CONTROL SYSTEM AND IMPLEMENTING METHOD FOR THE SAME

(71) Applicant: TSU-CHING CHIN, Hsinchu County (TW)

(72) Inventor: TSU-CHING CHIN, Hsinchu County (TW)

(21) Appl. No.: 14/805,643

(22) Filed: Jul. 22, 2015

(30) Foreign Application Priority Data
Jul. 31, 2014 (TW) 103126172

(51) Int. Cl. G08B 17/10; G08B 25/10; G08C 17/02

(52) U.S. Cl. CPC G08B 17/10; G08C 17/02; G08B 25/10

(57) ABSTRACT

A smart remote stove fire monitor and control system and its implementing method, which comprises a gas monitoring device is disclosed. The gas monitoring device is locating between a gas supply site and a gas using site. Users can use a smart communication device to connect with the gas monitoring device. Therefore, when the gas supply site deliver the gas to the gas using site, the gas monitoring device will detect the gas usage data. Furthermore, once users bring their smart communication device out of a signal detection range, the gas monitoring device will block the gas supply according to the gas usage data. This application can effectively prevent that the gas using site occurs a status of dry combustion or gas leak because of the user forgetting to turn off the gas using site when the user was out.

### BACKGROUND OF THE INVENTION

1. Field of the Invention

The present disclosure relates to stove fire monitor and control system, and in particularly to smart remote stove fire monitor and control system and implementing method for the same.

2. Description of Related Art

According to the statistical table of number of nationwide fire accidents, causes of fire accidents and damage of fire accidents of National Fire Agency of Ministry of the Interior in Taiwan, the damage of houses and property reaches up to 533121 thousand dollar in 2013, in which the most common fire accident region in home environment is the kitchen. According to the statistical table, there are 63 fire accidents caused by careless use of cooking stove fire and 26 fire accidents caused by gas leak or gas explosion. This shows that the operation of cooking stove fire equipment in the kitchen, the use habit of fire stove and so forth directly affect the safety of life and property of households.

The patent application of the related art for monitoring stove fire in kitchen such as the R.O.C. (Taiwan) patent application titled, “Integrated Home Gas Safety System”, and having patent number M427499 had disclosed an integrated home gas safety system mainly connected to a gas supply site for ensuring user's safety.

More specifically, above integrated home gas safety system comprises a smart gas flow calculation machine, a gas meter, a plurality of sensing elements, an emergency blocking valve, a radiofrequency (RF) device and a smart integrated device. The smart gas flow calculation machine comprises a plurality of status modules, a display and a network device. The aforesaid smart gas flow calculation machine can detect gas via each sensing element. When detecting gas leak, the smart gas flow calculation machine can enable the emergency blocking valve for blocking gas provided by the gas supply site.

However, following problem can be understood according to above description. When a user goes out and forgets to turn off the gas stove fire during cooking, the stove fire will continuously burn, never extinguish and make a cookware on the gas stove be the status of dry combustion. Because the gas stove fire never extinguishes and never imperfectly burns, the gas stove fire will still normally burn. In this time, the smart gas flow calculation machine will fail to detect the abnormal status because none of the sensing element is effective to detect the status of dry combustion.

However, with the status of dry combustion worsening, it could cause that the cookware fires and the fire spreads to the kitchen. Therefore, there is a need to find out a better and more effective solution to handle such problems.

### SUMMARY OF THE INVENTION

In view of the above problem, the inventors of the present invention research and analysis a gas stove safety turn-off system of the related art to wish to provide a better stove fire monitor and control system according to years of experience of the worked related industries and product design. Thus, the main object of the present invention is to provide a smart remote stove fire monitor and control system and its implementing method which can detect a wireless signal of a smart communication device, make the wireless signal as the determining condition further to monitor the stove fire and automatically block gas for preventing dry combustion.

For achieving above object, the present invention provides a smart remote stove fire monitor and control system and its implementing method. The aforesaid smart remote stove fire monitor and control system mainly comprises a gas monitoring device installed between a gas supply site and a gas using site and used to monitor a flow status of gas can block gas supply when determine that an abnormal status occurs according to the data retrieved during monitoring. Moreover, a user can use a smart communication device having installed and launched a gas control program to connect to the gas monitoring device through information connection. The gas monitoring device can continuously detect a wireless signal sent from the smart communication device. When the gas monitoring device is unable to receive the wireless signal, the gas monitoring device determines that the user is no longer within a signal receiving range (such as the range of house), and immediately blocks the gas supply to prevent the status of dry combustion of the cookware.

As mentioned above, the present invention can effectively reduce the incidence of fire accidents. Besides, because the user only needs to make the gas control program launch, the smart remote stove fire monitor and control system only needs to use the wireless signal as the determining condition of blocking the gas, the present invention is easy to operate and can save the using amount of the gas.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a first composition schematic diagram according to the present invention;

FIG. 2 is a second composition schematic diagram according to the present invention;

FIG. 3 is a flowchart of the implementing steps according to the present invention;

FIG. 4 is a first implementing schematic diagram of the first embodiment according to the present invention;

FIG. 5 is a second implementing schematic diagram of the first embodiment according to the present invention;

FIG. 6 is a third implementing schematic diagram of the first embodiment according to the present invention;

FIG. 7 is a fourth implementing schematic diagram of the first embodiment according to the present invention;

FIG. 8 is a fifth implementing schematic diagram of the first embodiment according to the present invention;

FIG. 9 is a sixth implementing schematic diagram of the first embodiment according to the present invention;

FIG. 10 is a seventh implementing schematic diagram of the first embodiment according to the present invention;

FIG. 11 is an implementing schematic diagram of the second embodiment according to the present invention;

FIG. 12 is an implementing schematic diagram of the third embodiment according to the present invention;

FIG. 13 is an implementing schematic diagram of the fourth embodiment according to the present invention;

FIG. 14 is an implementing schematic diagram of the fifth embodiment according to the present invention; and

FIG. 15 is an implementing schematic diagram of the sixth embodiment according to the present invention.

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

In the following description, a preferred embodiment is explained with associated drawings.

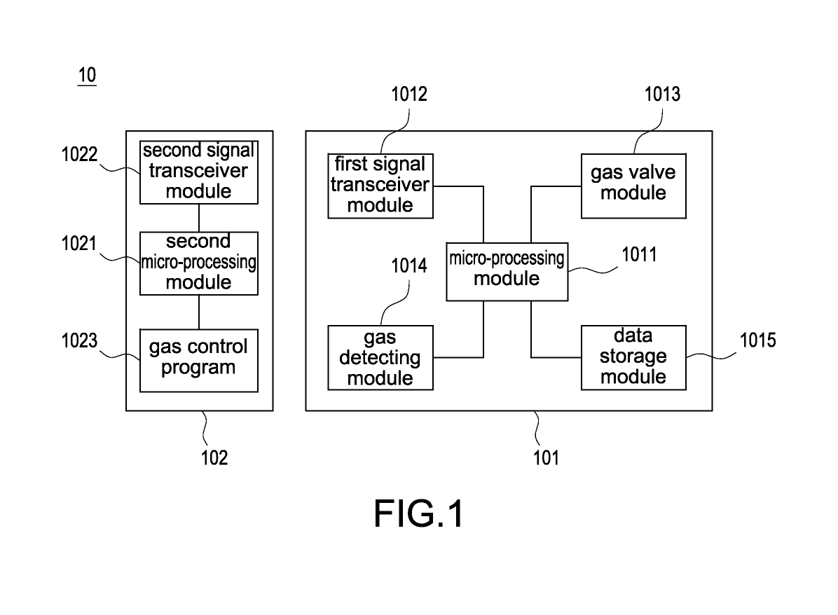

First, please refer to FIG. 1, which illustrates a first composition schematic diagram according to the present invention. As shown in FIG. 1, a smart remote stove fire monitor and control system 10 of the present invention mainly comprises a gas monitoring device 101 and a smart communication device 102. The aforesaid smart communication device 102 can be a portable mobile device with capability of communication, such as smartphone, PDA, or tablet.

The aforesaid gas monitoring device 101 comprises a first micro-processing module 1011, a first signal transceiver module 1012, a gas valve module 1013, a gas detecting module 1014 and a data storage module 1015 respectively connected to the first micro-processing module 1011 through information connection. The aforesaid first micro-processing module 1011 can control the gas valve module 1013 to turn on/off, and can be microprocessor control unit (MCU), Central processing unit (CPU), Micro Processor Unit (MPU) or Digital signal processing (DSP), but this specific example is not intended to limit the scope of the present invention.

The aforesaid first signal transceiver module 1012 can be used to detect a wireless signal. The gas monitoring device 101 can be further connected to the smart communication device 102 through information connection via the first signal transceiver module 1012, wherein the aforesaid information connection can be Wireless Fidelity (Wi-Fi), Bluetooth, or Infrared (IR).

The gas valve module 1013 can be used to block the flow of gas. The gas detecting module can be flowmeter, pressure gauge or flow pressure detector and is used to detect the flow rate, pressure of gas, generate a gas flow value data after detection, as well as further stores the gas flow value data in the data storage module 1015.

The aforesaid smart communication device 102 comprises a second micro-processing module 1021 and a second signal transceiver module 1022 connected to the second micro-processing module 1021 though information connection. The smart communication device 102 is further installed a gas control program 1023 being executed to drive the second signal transceiver module 1022 to send the wireless signal. Moreover, the aforesaid second micro-processing module 1021 can be used to execute the command(s) generated by the gas control program 1023, and can be exemplified to be microprocessor control unit (MCU). The aforesaid second signal transceiver module 1022 can send the wireless signal to the first signal transceiver module 1012 of the gas monitoring device 101 to make first signal transceiver module 1012 connect to the second signal transceiver module 1022 though information connection.

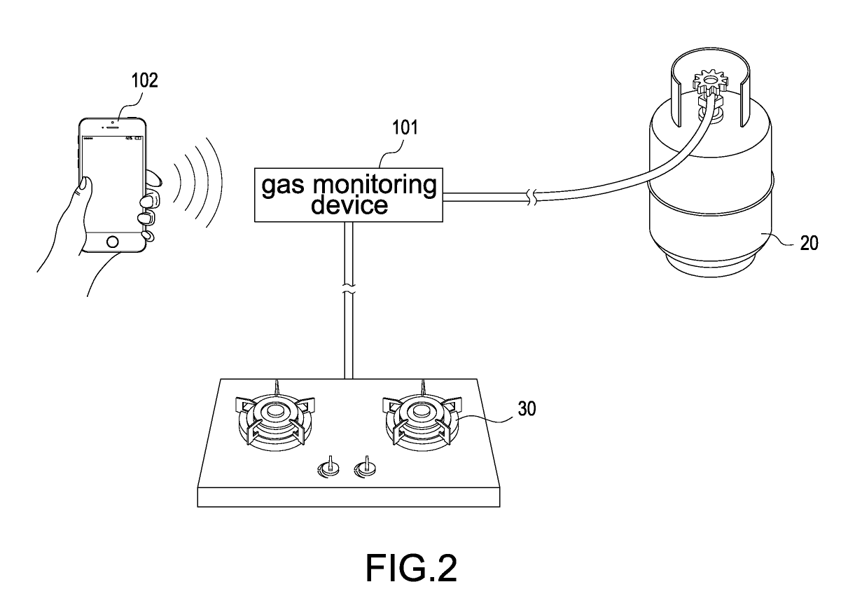

Please also refer to FIG. 2, which illustrates a second composition schematic diagram according to the present invention. As shown in FIG. 2, the gas monitoring device 101 is mainly installed on a gas pipeline between a gas supply site 20 and a gas using site 30, the aforesaid gas supply site 20 can be gas pipeline system or bottled gas. Additionally, after installation, the gas supply site 20 can output gas to the user using site 30 using the gas pipeline. When the abnormal status occurs, for example, the status of gas leak or dry combustion, the gas valve module 1013 of the gas monitoring device 101 can turn off and block the gas delivered from the gas supply site 20 to the gas using site 30 by control for preventing that the gas continuously leaks or burns.

In the present invention, a user can connect to the gas monitoring device 101 though information connection via the smart communication device 102. When the smart communication device 102 is located within a signal receiving range of the gas monitoring device 101, the gas valve module 1013 of the gas monitoring device 101 immediately appears a turn-on status; otherwise, when the user bring the smart communication device 102 out of the signal receiving range, the gas monitoring device 101 immediately determines the user had gone out, and turns off the gas valve module 1013 of the gas monitoring device 101 to stop to deliver the gas to the gas using site 30.

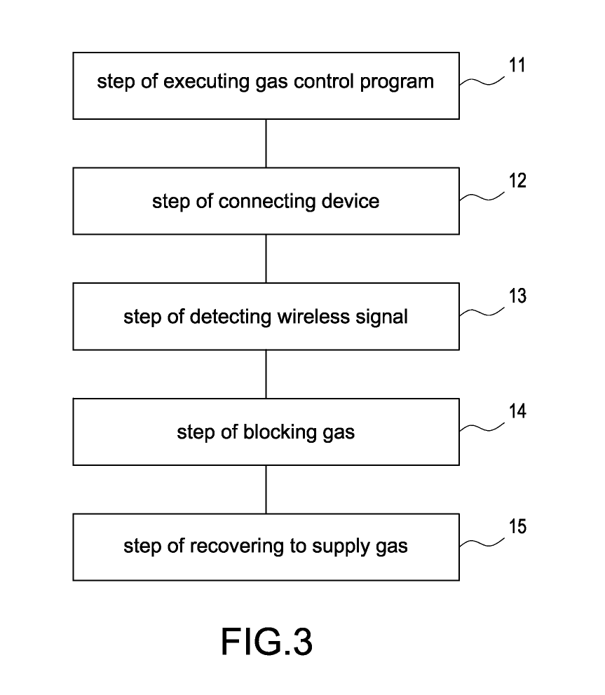

Please refer to FIG. 3, which illustrates a flowchart of the implementing steps according to the present invention, and simultaneously refer to FIG. 3-10, which respectively illustrate first to seventh implementing schematic diagrams in the first embodiment according to the present invention. The content shown in FIG. 3 is the implementing steps of the smart remote stove fire monitor and control system 10 of the present invention, comprising:

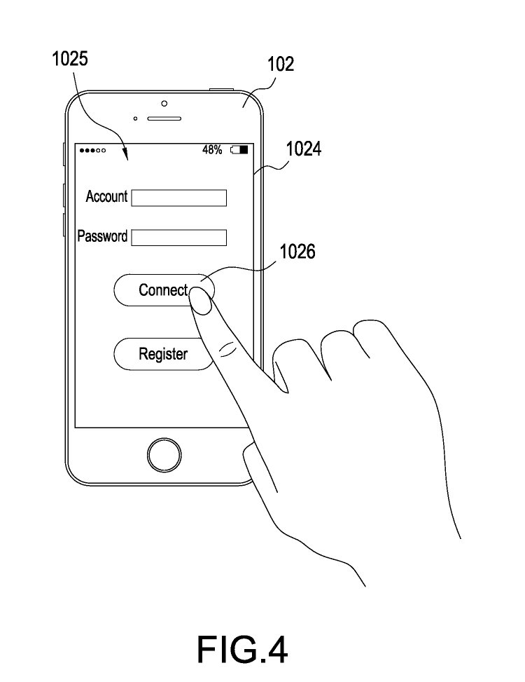

(1) A step 11 of executing gas control program: as shown in FIG. 4, a user can perform touch operation on a touchscreen 1024 of the smart communication device 102, and execute the aforesaid gas control program 1023 via operating on the touchscreen 1024. After the gas control program 1023 is launched, an operation interface 1025 is displayed on the touchscreen 1024, and the operation interface 1025 comprises at least one connection option term 1026;

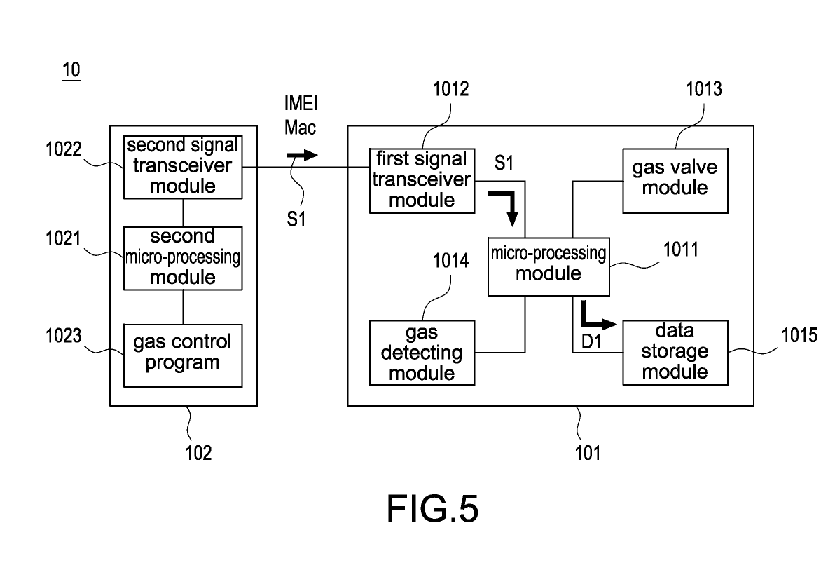

(2) A step 12 of connecting device: as shown in FIG. 5, as mentioned above step, after the user touches the connection option term 1026, the second signal transceiver module 1022 of the smart communication device 102 is driven to send a wireless signal S1. The aforesaid can be encoded by the gas control program 1023 to comprise a device identification information D1 of the smart communication device 102, such as International Mobile Equipment Identity (IMEI) number or Media Access Control Address (MAC address), but this specific example is not intended to limit the scope of the present invention. After the first signal transceiver module 1012 of the gas monitoring device 101 detects the wireless signal S1, the smart communication device 102 can connect to the gas monitoring device 101 though information connection. The micro-processing module 1011 of the gas monitoring device 101 further decodes the wireless signal S1 for retrieving the device identification information D1, and stores the retrieved device identification information D1 in the data storage module 1015 for making the gas monitoring device 101 bind the smart communication device 102;

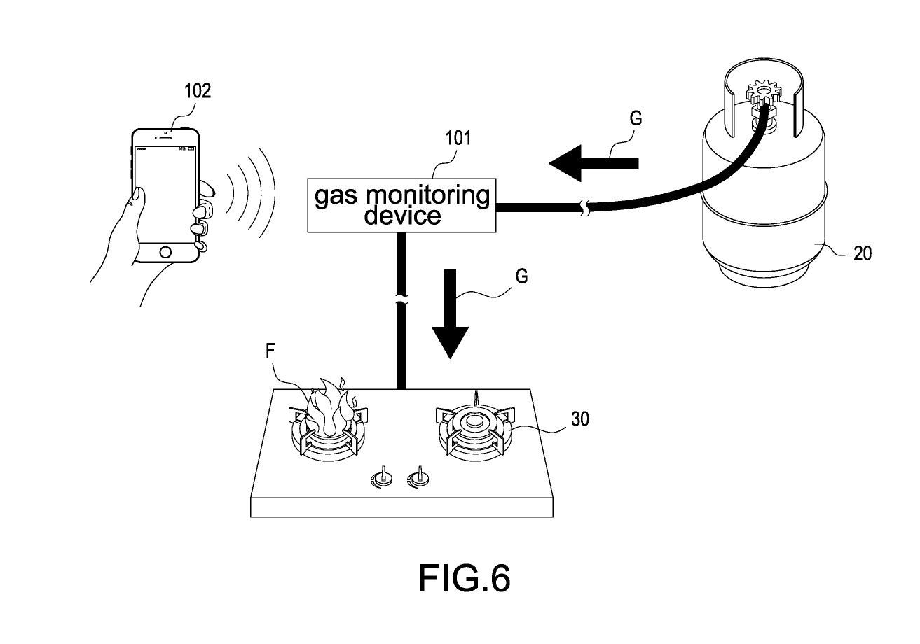

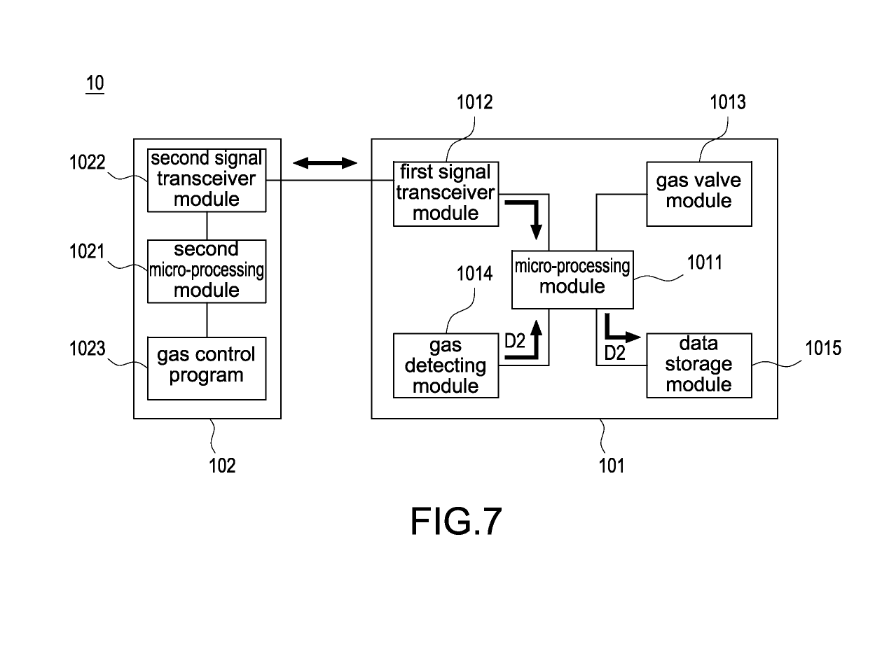

(3) A step 13 of detecting wireless signal: as shown in FIG. 6, as mentioned above step, the gas monitoring device 101 continuously keeps a status of connecting to the smart communication device 102 though information connection to make the first signal transceiver module 1012 of the gas monitoring device 101 continuously receive the wireless signal S1 sent from the second signal transceiver module 1022 of the smart communication device 102. In this status, the first micro-processing module 1011 of the gas monitoring device 101 controls the gas valve module 1013 to continuously keep in turn-on status further to make the gas supply site 20 deliver a gas G to the gas using site 30 via the gas pipeline. As shown in FIG. 7, when the gas using site 30 is in the in-use status (as shown in this figure, the gas user site 30 is ignited and generates a stove fire F), the gas detecting module 1014 can detect the flow rate or pressure of gas delivered from gas supply site 30 to the gas using site 30, and generate a gas flow value data D2. After the micro-processing module 1011 receives the gas flow value data D2, the micro-processing module 1011 can store the gas flow value data D2 in the data storage module 1015. Besides, the micro-processing module 1011 further determines the usage status of the gas using supply 30 according to a data variation value of the gas flow value data D2. For example, the gas using site 30 is in an unused status, a gas flow value of the gas flow value data D2 is zero; otherwise, the gas using site 30 is in the in-use status, the gas flow value of the gas flow value data D2 is greater than zero;

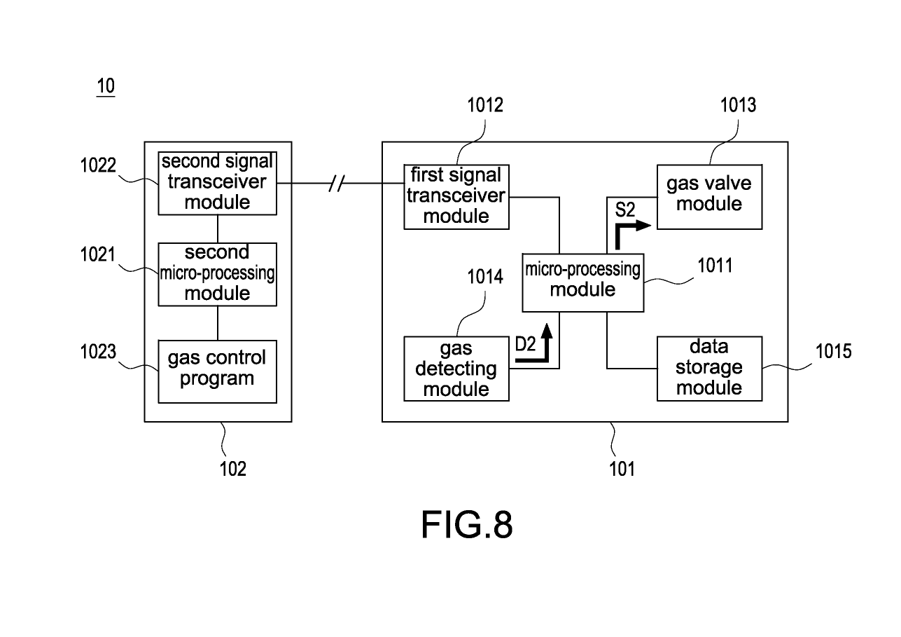

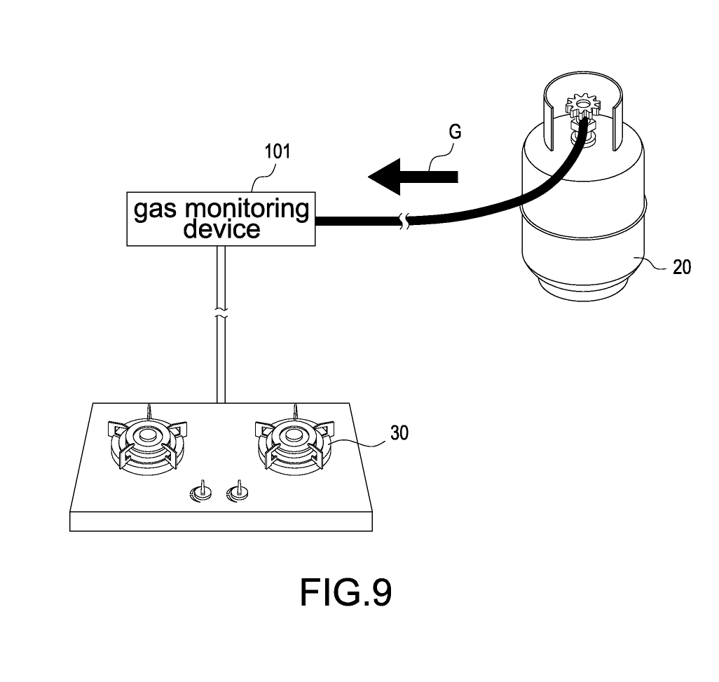

(4) A step 14 of blocking gas: as shown in FIG. 8, as mentioned above step, when the user brings the smart monitoring device 102 out, and the first signal transceiver module 1012 of the gas monitoring device 101 is unable to receive the wireless signal S1 for a time of specific value (such as within 10 minutes), the micro-processing module 1011 can transfer a control signal S2 to the gas valve module 1013 to control the gas valve module 1013 to compulsorily turn off. As shown in FIG. 9, after the gas valve module 1013 blocks the gas G, the gas using site 30 can no longer burn (as shown in FIG., the stove fire of the gas using site 30 extinguishes caused by the gas G being blocked), and make the gas G stay in the gas pipeline of the gas supply site 20 further to prevent the gas G from continuously delivering out. Besides, as shown in FIG. 8, when the gas G continuously flows, the gas detecting module 1014 can keep detecting the gas G, and the micro-processing module 1011 can make the latest gas flow value data D2 as a reference value, and detect the usage status of the gas using site 30. For example, when the first signal transceiver module 1012 is unable to detect the wireless signal S1, if the micro-processing module 1011 fails to immediately block the gas G, the micro-processing module 1011 can refer to the gas flow value data D2. More specifically, when the first signal transceiver module 1012 is unable to detect the wireless signal S1 and the gas flow value of the gas flow value data D2 is still greater that zero, the micro-processing module 1011 can turn off the gas valve module 1013;

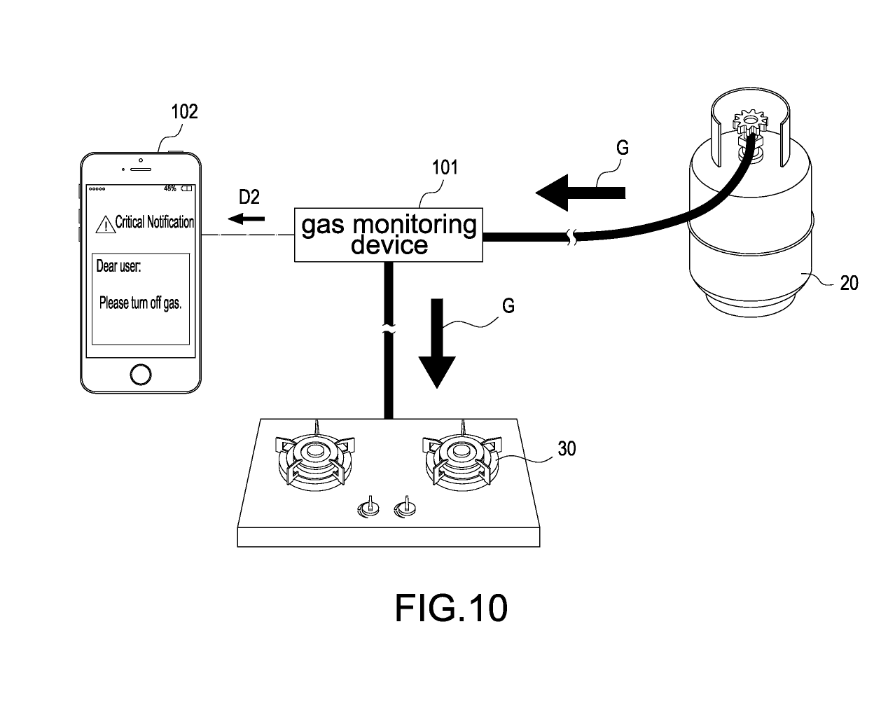

(5) A step 15 of recovering to supply gas: as shown in FIG. 10, as mentioned above step, when the user returns to the site, after the gas monitoring device 101 recovers to establish information connection with the smart communication device 102, the micro-processing module 1011 can turn on the gas valve module 1013 again to recover to deliver the gas G out. At the same time, the micro-processing module 1011 can transfer the gas flow value data D2 stored in the data storage module 1015 to the smart communication 102 via the first signal transceiver module 1012 for making the gas control program 1023 display data on the touchscreen 1024 to user after receive the gas flow value data D2. Moreover, when the gas detecting module 1014 detects the gas flow value data D2 is greater than zero (>0), namely the gas using site 30 is in the turn-on status, the micro-processing module 1011 can send a warning message to the smart communication device 102 for reminding the user to turn off a switch of the gas using site 30 via the first signal transceiver module 1012. If the user doesn't immediately turn off it, the gas monitoring device 101 can continuously send the warning message to the smart communication device 102, and the gas monitoring device 101 can first automatically turn off the gas valve module 1013, then execute aforesaid reminder and detection again until the switch of the gas using site 30 being turned off. Moreover, after the switch of the gas using site 30 is turned off, the gas detecting module 1014 will detect that the gas flow value data D2 is equal to zero, the micro-processing module 1011 can control the gas valve module 1013 to turn on for making the gas using site 30 is operable to the user.

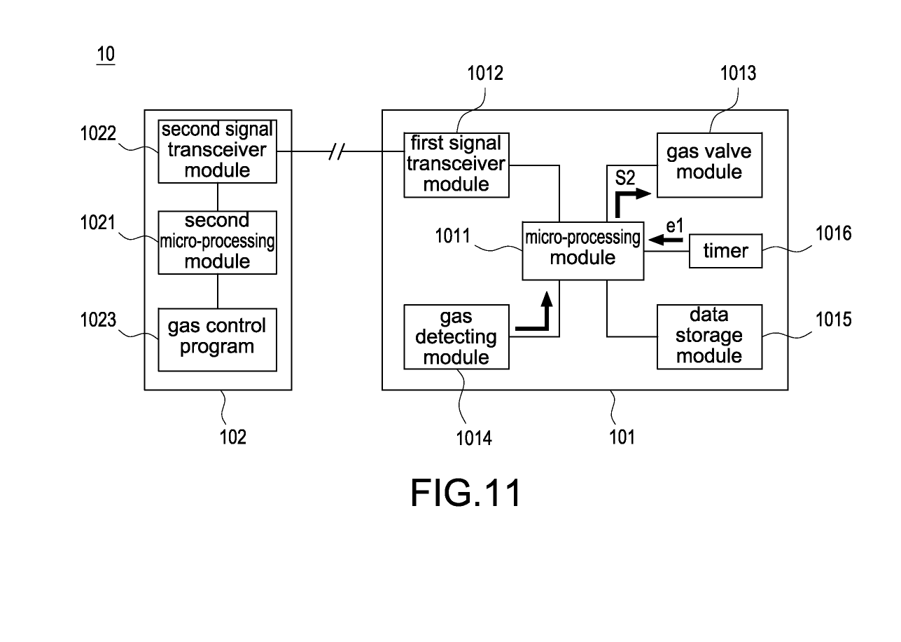

Please refer to FIG. 11, which illustrates an implementing schematic diagram in the second embodiment according to the present invention. As shown in FIG. 11, the gas monitoring device 101 can further comprise a timer 1016 which is connected to the micro-processing module 1011 though information connection, the user can configure a time of turning off the gas valve module 1013 by the micro-processing module 1011 via the timer 1016. For example, when the gas monitoring device 101 is unable to detect the smart communication device 102, the timer 1016 immediately start to count time (such as 10 seconds), when time's up, the timer 1016 can send an electric signal e1 to the micro-processing module 1011 further to make the first micro-processing module 1011 compulsorily turn off the gas valve module 1013 for preventing the gas using site 30 from dry combustion or gas leak.

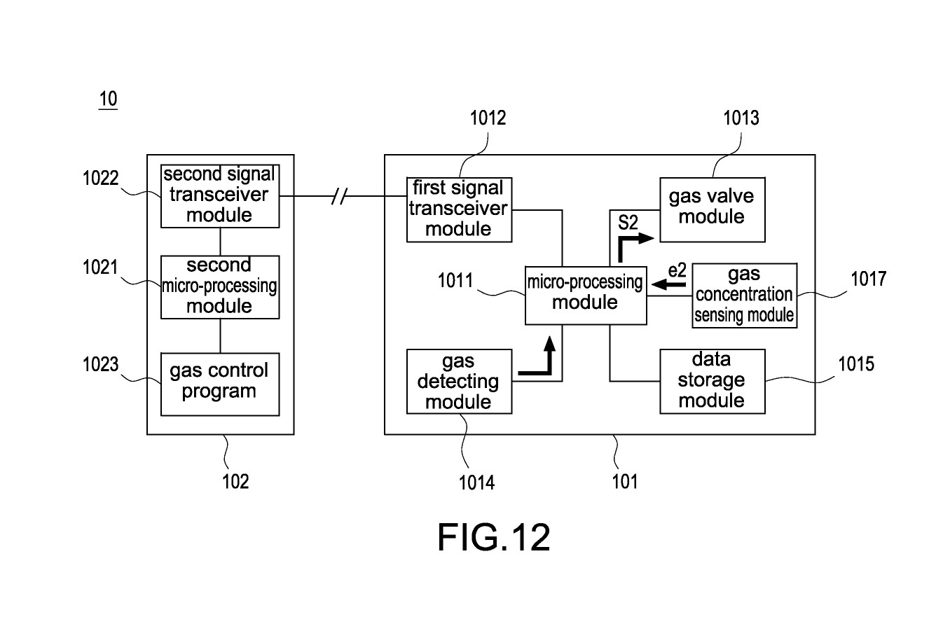

Please refer to FIG. 12, which illustrates an implementing schematic diagram in the third embodiment according to the present invention. As shown in FIG. 12, the gas monitoring device 101 can further comprise a gas concentration sensing module 1017 which is connected to the micro-processing module 1011 though information connection and used to detect a fuel gas value of the gas (G). When gas leak or imperfectly burning occurs in the gas using site 30, the gas concentration sensing module 1017 can immediately sense the fuel gas value in site environment. When the fuel gas value reaches a safety standard value, the gas concentration sensing module 1017 can send an electric signal e2 to the micro-processing module 1011 to make the micro-processing module turn off the gas valve module 1013 for preventing the gas of the gas using site 30 from leaking out.

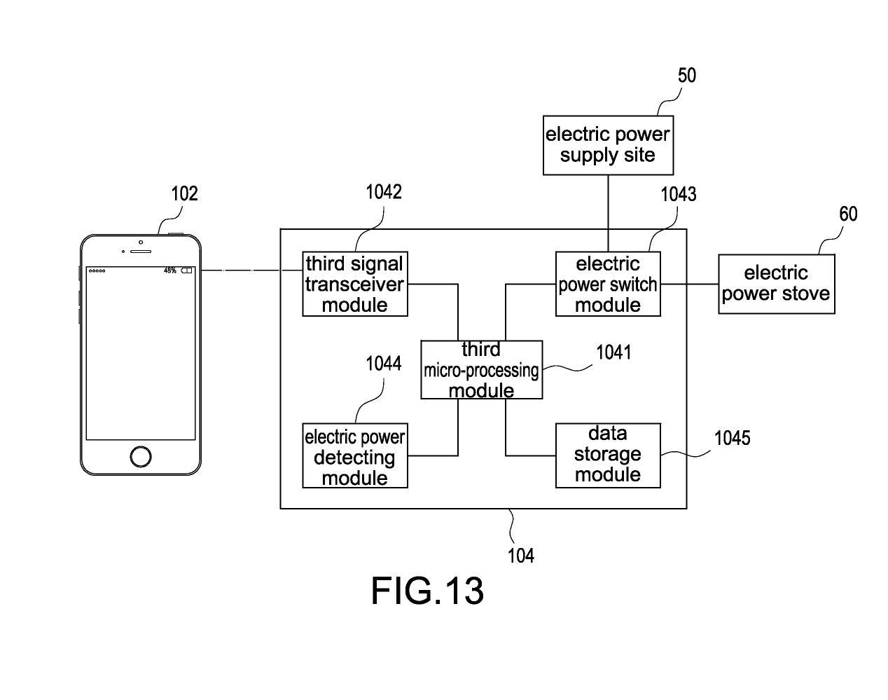

Please refer to FIG. 13, which illustrates an implementing schematic diagram in the fourth embodiment according to the present invention. As shown in FIG. 13, the present not only can be used to monitor the stove fire apparatus using gas, but also monitor the stove fire apparatus mainly using electric power. Please refer to a smart remote stove fire monitor and control system 10′ shown in FIG., the smart remote stove fire monitor and control system 10′ mainly comprises a smart communication device 102 and an electric power monitoring device 104, wherein the smart communication device 102 installs an electric power control program. Besides, the electric power monitoring device 104 is installed on an electrical cable between an electric power supply site 20 and an electric power stove 60.

The electric power monitoring device 104 connects to the smart communication device 102 though information connection, the aforesaid electric power monitoring device 104 comprises a third micro-processing module 1041, and a third signal transceiver module 1042, an electric power switch module 1043, an electric power detecting module 1044 and a data storage module 1045 which connected to the third micro-processing module 1041 though information connection. The aforesaid electric power switch module 1043 is used to block or turn on an electric power delivered from the electric power supply site 50 to the electric power stove 60, and can be controlled by the third signal transceiver module 1042. The electric power switch module of this embodiment can be solenoid valve or electronic switch, but this specific example is not intended to limit the scope of the present invention.

The electric power detecting module 1044 is used to detect an electric power usage data (such as a current value, a voltage value) of the electric power delivered from the electric power supply site 50 to the electric power stove 60, and can generate an electric power value data after detection, and further stores it in the data storage module 1045. In this embodiment, the electric power detecting module 1044 can be galvanometer, voltmeter or current and voltage detector meter, but this specific example is not intended to limit the scope of the present invention.

Via the electric power monitoring device 104, this embodiment can monitor the stove fire apparatus mainly using electric power, the detailed implementation is similar as the implementations shown in FIG. 3-10, the relevant description is omitted for brevity.

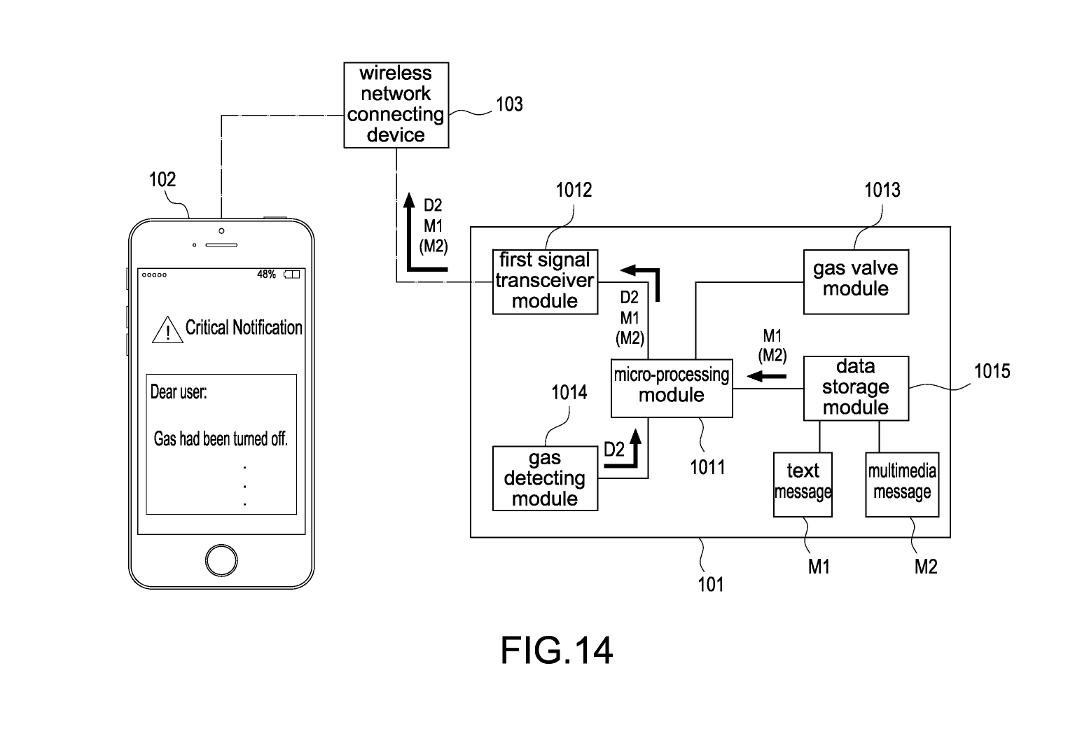

Please refer to FIG. 14, which illustrates an implementing schematic diagram in the fifth embodiment according to the present invention. Please refer in conjunction with the FIG. 1 and FIG. 13. As shown in these figures, the first signal transceiver module 1012 of the gas monitoring device 101 can connect to a wireless network connecting device 103 though information connection. When the user brings the smart communication device 102 out, the gas monitoring device 101 can immediately send the gas flow value data D2 or a notification message to the smart communication device 102 via the wireless network connecting device 103 for providing the user to view. In this embodiment, the data storage module 1015 can pre-store the notification message, the aforesaid notification message can be a text message M1 or a multimedia message M2, for example, “Dear user, because your signal is unable to be detected, we had compulsorily turned off your gas for your safety”.

Besides, the aforesaid text message M1 can be a message using SMS format, the multimedia message M2 can be MMS. Moreover, the first signal transceiver module 1012 can send the text message M1 or multimedia message M2 though IFTTT (if this then that) network service platform with the format compatible with social network website message, communication APP (such as line, whatAPP, WeChat) via the wireless network connecting device 103, but this specific example is not intended to limit the scope of the present invention.

Additionally, this embodiment can also apply to the smart remote stove fire monitor and control system 10′ shown in FIG. 13. This, it can make the electric power monitoring device 104 send the electric power usage data to the smart communication device 102 or execute the related control.

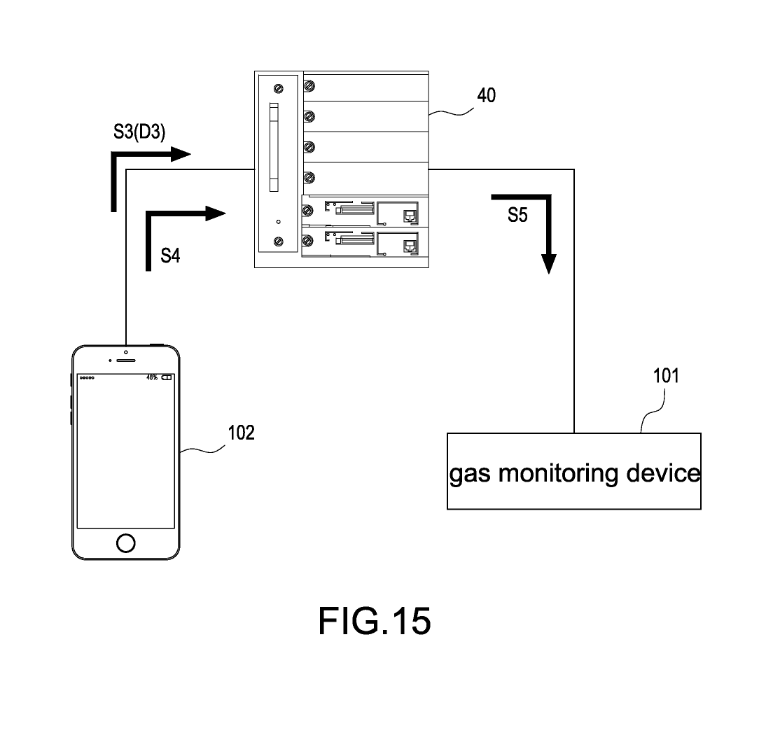

Please refer to FIG. 15, which illustrates an implementing schematic diagram in the sixth embodiment according to the present invention. As shown in FIG., the second signal transceiver module 1022 of the smart communication device 102 can further connect to a service center or a service center server 40 though information connection, wherein the aforesaid service center can also install the service center server 40, and the first signal transceiver module 1012 of the gas monitoring device 101 can also establish information connection with the service center or the service center server 40 via the wireless network connecting device 103.

In this embodiment, when the user completes the step 11 of executing gas control program, can further establish information connection with the service center or the service center server 40 using the smart communication device 102, and apply a registration request S3 to the service center or the service center server 40 for uploading an identity identification data D3 to the service center or service center server 40 to register. The aforesaid identity identification data D3 can comprise the device identification information D1 of the smart communication device 102, the user personal data or identity authentication password.

As mentioned above, when the user wants to execute the aforesaid step 15 of recovering to supply gas, the user can immediately connect to the service center server 40 using the smart communication device 102, and the user can apply a recovering status request S4 to the service center or the service center server after input the identity identification data D3 and complete the identity authentication by the service center or the service center server. After receiving the recovering status request S4, the service center or the service center server 40 can send a corresponded recovering status command S5 to the gas monitoring device 101. After the micro-processing module 1011 receives the recovering status command S5, compulsorily controls the gas valve module to recover the original status.

Additionally, when the user goes out and doesn't bring the smart communication device 102, because the gas monitoring device 101 still connects to the smart communication device 102 though information connection, the gas monitoring device 101 will continuously keep the gas valve module turning on. When this status occurs, the user can connect to the service center or the service center server via another communication device, and the service center or the service center server can immediately compulsorily control the gas valve module 1013 after authenticate the identity of the user via the service center or the service center server. Moreover, after the user goes home, the service center or the service center server can allow the user to directly control the gas valve module 1013.

This embodiment can also apply to aforesaid smart remote stove fire monitor and control system 10′. More specifically, the user can compulsorily control the electric power switch module 1043 of the electric power monitoring device 104 via another communication device though service center or service center server 40. Therefore, when the user goes out and leaves the smart communication device 102 home, the user can still control the gas monitoring device 101 or the electric power monitoring device 104 though service center or the service center server 40 via another communication device. Thus, the user can remotely control the stove fire, gas or electric power of home to prevent careless use of fire.

The smart remote stove fire monitor and control system and its implementing method of the present invention mainly install a gas monitor device between a gas supply site and a gas using site, a user can use a smart communication device to launch a gas control program to make the smart communication device send a wireless signal, and complete to connect to each other though information connection after the gas monitoring device detects the wireless signal.

When the gas supply site delivers a gas to the gas using site via gas monitoring device, a gas detecting module of the gas monitoring device can detect the gas and generate a gas flow value data (flow rate value or pressure value of gas). When the user brings the smart communication device out of range of wireless signal, the first micro-processing module can compulsorily turn off a gas valve module to block the gas delivered to the gas using site to prevent from the status of cookware dry combustion caused by continuously cooking. Moreover, the gas monitoring device of the present invention further comprises a gas concentration sensing module which can be used to detect a fuel gas value of the environment to make the micro-processing module determine whether the gas leaks according to the fuel gas value, and make the fuel gas value be the basis of blocking gas.

Additionally, the first signal transceiver module of the gas monitoring device can connect to a wireless network connecting device though information connection, when the user goes out, the gas monitoring device can send a text message or a voice message to the smart communication device to notify the status of stove fire via a wireless network connection. Moreover, the first signal transceiver module can further connect to a service center or a service center server via the wireless network connecting device. Thus, the user can use the smart communication device or another communication device to connect to the same service center or service center server, and remotely control the gas valve module via the service center or service center server. Moreover, the present invention can also apply to electric power stove fire apparatus using the electric power as energy. The present invention can block an energy source of an electric power stove via controlling an electric power output status of an electric power supply site. In summary, after the implement of the present invention, the present invention really can provide a smart remote stove fire monitor and control system and its implementing method which can detect a wireless signal of a smart communication device, make the wireless signal as the determining condition further to monitor the stove fire and automatically block gas for preventing dry combustion.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended.

What is claimed is:

1. A smart remote stove fire monitor and control system (10) used to monitor a flow status of the gas (G) flowed between a gas supply site (20) and a gas using site (30), the smart remote stove fire monitor and control system (10) can block the gas supply site (20) from continuously supplying the gas (G) when an abnormal status is occurred, the smart remote stove fire monitor and control system (10) comprising:
a gas monitoring device (101) comprising a first micro-processing module (1011), a first signal transceiver module (1012) connected to the first micro-processing module (1011) through information connection and a gas valve module (1013), wherein the first micro-processing module (1011) controls the gas valve module (1013) to turn on/off;
a smart communication device (102) comprising a second micro-processing module (1021) and a second signal transceiver module (1022) connected to the second micro-processing module (1011) through information connection;
a gas control program (1023) installed in the smart communication device (102) being executed to drive the second signal transceiver module (1022) of the smart communication device (102) to continuously send a wireless signal (S1), and the first signal transceiver module (1012) of the gas monitoring device (101) continuously receiving the wireless signal (S1);
wherein, when the first signal transceiver module (1012) is unable to receive the wireless signal (S1) for a time of specific value, the first micro-processing module (1011) control the gas valve module (1013) to be turned off to make the gas supplied by the gas supply site (20) be blocked by the gas valve module (1013).

2. The smart remote stove fire monitor and control system (10) according to claim 1, wherein the gas monitoring device (101) further comprises a timer (1016) connected to the first micro-processing module (1011) through information connection and used to configure the time of specific value.

3. The smart remote stove fire monitor and control system (10) according to claim 1, wherein the gas monitoring device (101) further comprises a gas detecting module (1014) connected to first micro-processing module (1011) through information connection and used to continuously detect the flow status of the gas (G) and generate gas flow value data (D2).

4. The smart remote stove fire monitor and control system (10) according to claim 3, wherein the gas monitoring device (101) further comprises a data storage module (1015) connected to first micro-processing module (1011) through information connection and used to store the gas flow value data (D2).

5. The smart remote stove fire monitor and control system (10) according to claim 4, wherein the gas monitoring device (101) further comprises a timer (1016) connected to the first micro-processing module (1011) through information connection and used to configure the time of specific value.

6. The smart remote stove fire monitor and control system (10) according to claim 1, further comprising a wireless network connecting device (103) connected to the first signal transceiver module (1012) of the gas monitoring device (101) through information connection and used to send a notification message to the smart communication device (102).

7. The smart remote stove fire monitor and control system (10) according to claim 6, further comprising a service center server (40) connected to the gas monitoring device (101) and the smart communication device (102) through information connection, the service center server (40) can control the gas monitoring device (101) according to a request of the smart communication device (102).

8. The smart remote stove fire monitor and control system (10) according to claim 6, further comprising a service center connected to the gas monitoring device (101) and the smart communication device (102) through information connection, the service center can control the gas monitoring device (101) according to a request of the smart communication device (102).

9. A method of implementing a smart remote stove fire monitor and control system (10), wherein a smart communication device (102) establishes relative information connection with a gas monitoring device (101) sited between a gas supply site (20) and a gas using site (30) after a gas control program (1023) is executed in the smart communication device (102), the gas monitoring device (101) is used to monitor and control a flow status of a gas (G), comprising:
a step (13) of detecting wireless signal: the gas monitoring device (101) and the smart communication device (102) continuously keeping a status of connecting though information connection to make a first signal transceiver module (1012) of the gas monitoring device (101) can continuously receive a wireless (S1) sent from a second signal transceiver module (1022) of the smart communication device (102), in this status, a first micro-processing module (1011) of the gas monitoring device (101) controlling a gas valve module (1013) of the gas monitoring device (101) to continuously keep in turn-on status; and
a step (14) of blocking gas: the first micro-processing module (1011) controlling the gas valve module (1013) to compulsorily turn off when the first signal transceiver module (1012) of the first micro-processing module (1011) is unable to receive the wireless signal (S1) for a time of specific value.

10. The method of implementing the smart remote stove fire monitor and control system (10) according to claim 9, wherein the step (13) of detecting wireless signal is executed, and meantime the gas detecting module (1014) of the gas monitoring device (101) detects the flow status of the gas (G) flowed between the gas supply site (20) and the gas using site (30), and generates gas flow value data (D2) when detection, the gas flow value data (D2) is stored in a data storage module (1015) of the gas monitoring device (101) to make the micro-processing module (1011) determine a usage status of the gas using site (30) with the gas flow value data (D2).

11. The method of implementing the smart remote stove fire monitor and control system (10) according to claim 9, wherein the step (13) of detecting wireless signal is executed, and meantime a gas concentration sensing module (1017) of the gas monitoring device (101) executes a concentration detection of a fuel gas value in site environment of the gas using site (30), when the fuel gas value reaches a safety standard value, execute the step (14) of blocking gas.

12. The method of implementing the smart remote stove fire monitor and control system (10) according to claim 9, wherein a step (15) of recovering to supply gas follows behind the step (14) of blocking gas, wherein the step (15) of recovering to supply gas comprises that the gas control program (1023) sending a driving signal to the gas monitoring device (101) to make the micro-processing module (1011) control the gas valve module (1013) to turn on after the gas monitoring device (101) recovers to establish information connection with the smart communication device (102).

13. The method of implementing the smart remote stove fire monitor and control system (10) according to claim 12, wherein the gas detecting module (1014) continuously detects the gas using site (30) and sends a warning message to the smart communication device (102) after the gas valve module (1013) is turned on.

14. a smart remote stove fire monitor and control system (10′) used to monitor a flow status of an electric power flowed between an electric power supply site (50) and an electric power stove (60), the smart remote stove fire monitor and control system (10′) can block the electric power supply site (50) from continuously supplying the electric power when an abnormal status is occurred, the smart remote stove fire monitor and control system (10′) comprising:
an electric power monitoring device (104) comprising a third micro-processing module (1041), a third signal transceiver module (1042) connected to the third micro-processing module (1041) through information connection, and an electric power switch module (1043), wherein the third micro-processing module (1041) controls the electric power switch module (1043) to turn on/off;
a smart communication device (102) comprising a second micro-processing module (1021) and a second signal transceiver module (1022) connected to the second micro-processing module (1011) through information connection;
an electric power control program installed in the smart communication device (102) being executed to drive the second signal transceiver module (1022) of the smart communication device (102) to continuously send a wireless signal (S1), and the third signal transceiver module (1042) of the electric power monitoring device (104) continuously receiving the wireless signal (S1);
wherein, when the third signal transceiver module (1042) is unable to receive the wireless signal (S1) for a time of specific value, the third micro-processing module (1041) control the electric power switch module (1043) to turn off to make the electric power supplied by the electric power supply site (50) be blocked by the electric power switch module (1043).

15. The smart remote stove fire monitor and control system (10′) according to claim 14, wherein the electric power monitoring device (104) further comprises an electric power detecting module (1044) connected to third micro-processing module (1041) through information connection and used to detect the electric power flowed between the electric power supply site (50) and the electric power stove (60), generate an electric power usage data, and store the electric power usage data in a data storage module (104) connected to third micro-processing module (1041) through information connection.

16. The smart remote stove fire monitor and control system (10′) according to claim 14, further comprising a service center connected to the electric power monitoring device (104) and the smart communication device (102) through information connection, the service center server (40) can control the electric power monitoring device (104) according to a request of the smart communication device (102).

17. The smart remote stove fire monitor and control system (10′) according to claim 14, further comprising a service center connected to the gas monitoring device (101) and the smart communication device (102) through information connection, the service center can control the electric power monitoring device (104) according to a request of the smart communication device (102).
